(19) United States
(12) Patent Application Publication
(10) Pub. No.: US 2022/0187805 A1
(43) Pub. Date: Jun. 16, 2022

(54) PLANT OPERATING CONDITION DETERMINATION DEVICE, PLANT CONTROL SYSTEM, OPERATING CONDITION DETERMINATION METHOD AND PROGRAM

(71) Applicant: Mitsubishi Power, Ltd., Kanagawa (JP)

(72) Inventors: Yusuke HAZUI, Tokyo (JP); Masumi NOMURA, Tokyo (JP); Shigeru ANO, Yokohama-shi (JP); Kenta WADA, Yokohama-shi (JP); Koshiro FUKUMOTO, Yokohama-shi (JP)

(21) Appl. No.: 17/442,849

(22) PCT Filed: Mar. 24, 2020
(86) PCT No.: PCT/JP2020/012905

§ 371 Date: Sep. 24, 2021

(30) Foreign Application Priority Data
Apr. 24, 2019 (JP) 2019-082734

(51) Int. Cl. G05B 19/418

(52) U.S. Cl. CPC G05B 19/41865; G05B 19/4188; G05B 19/41885

(57) ABSTRACT

It is judged whether a first predicted value of an operation index obtained by inputting a scheduled change value of a manipulation parameter of a plant meets an operation criterion, and whether a second predicted value of the operation index obtained by inputting a virtual change value with a greater change amount from a current value than the scheduled change value to a prediction model meets the operation criterion. If it is judged that the first predicted value and the second predicted value meet the operation criterion, the scheduled change value is output as a command value of the manipulation parameter.

### TECHNICAL FIELD

The present disclosure relates to a plant operating condition determination device, a plant control system, an operating condition determination method and program.

### BACKGROUND

Plant operating conditions are generally determined so that a plant operation index meets an operation criterion. When the operating state of the plant is changed, a command value corresponding to a manipulation parameter corresponding to the changed operating state is output to final control elements of the plant, and an attempt is made to maintain the state in which the plant operation index meets the operating criterion.

As an example of such plant control, Patent Document 1 discloses a method for achieving plant control in which the plant operation index meets the operation criterion by learning a relationship between plant operating environment and control result, creating a learning result table in advance, and searching for a control method that satisfies the control target based on the learning result table.

### CITATION LIST

### Patent Literature

Patent Document 1: JPH9-34505A

### SUMMARY

### Problems to be Solved

In Patent Document 1, the control method is explored based on results of learning the relationship between the operating environment and the control result in the actual plant. Therefore, in order to achieve control with excellent reliability, it is necessary to accumulate a sufficient amount of learning under various operating conditions. However, in order to accumulate a sufficient amount of learning in the actual plant, a lot of time and cost is required due to, for example, trial operation.

One solution to this problem is to use prediction models such as physical models or statistical models created by statistical machine learning methods or neural network methods, for example, instead of past learning results. Specifically, by calculating from the prediction model a predicted value of the operation index when the manipulation parameter is changed from the current value, the control method with which the operation index meets the operation criterion is explored.

In plant control using such a prediction model, when the manipulation parameter is changed due to disturbance factors such as environmental changes or prediction errors in the prediction model, the actual operation index may differ from the predicted value obtained from the prediction model. For example, when the manipulation parameter is changed according to the prediction model so that the operation index reaches the target value (e.g., maximum or minimum value), if there is a region where the operation index dramatically changes near the target value, the operation index may change significantly from the target value when the manipulation parameter is changed due to disturbance factors such as environmental changes or prediction errors in the prediction model. At this time, if the operation index deviates from the operation criterion, it may lead to plant malfunctions or other problems.

At least one embodiment of the present invention was made in view of the above circumstances, and an object thereof is to provide a plant operating condition determination device, a plant control system, an operating condition determination method and program whereby it is possible to perform robust plant control against disturbance factors and prediction errors using a prediction model.

### Solution to the Problems

(1) To solve the above problem, a plant operating condition determination device according to at least one embodiment of the present invention comprises: a first judgement unit configured to judge whether a first predicted value of an operation index meets an operation criterion of a plant, the first predicted value being obtained by inputting a scheduled change value of one or more manipulation parameters to a prediction model showing a correlation between the operation index of the plant and an explanatory variable including a plurality of manipulation parameters of the plant; a second judgement unit configured to judge whether a second predicted value of the operation index meets the operation criterion of the plant, the second predicted value being obtained by inputting a virtual change value of the one or more manipulation parameters to the prediction model, wherein a change amount of the virtual change value from a current value of the one or more manipulation parameters is greater than that of the scheduled change value; and a manipulated variable change unit configured to output the scheduled change value as a command value of the one or more manipulation parameters if the first judgement unit and the second judgement unit judge that the first predicted value and the second predicted value meet the operation criterion.

With the above configuration (1), the first predicted value corresponding to the scheduled change value of the manipulation parameter and the second predicted value corresponding to the virtual change value with a change amount greater than the scheduled change value are calculated by the prediction model and judged whether to meet the operation criterion. If both the first predicted value and the second predicted value meet the operation criterion, the scheduled change value corresponding to the first predicted value is output as the command value. Thus, it is confirmed that the operation index meets the operation criterion until the virtual change value with a change amount greater than the scheduled change value. Therefore, even if the manipulation parameter is affected by disturbance factors or prediction errors when it is changed from the current value to the scheduled change value, the possibility of the operation index deviating from the operation criterion can be effectively reduced.

(2) In some embodiments, in the above configuration (1), the manipulated variable change unit is configured to select, from among two scheduled change values with different change amounts from the current value of the one or more manipulation parameters, a scheduled change value with a larger margin of another operation index of the plant to the operation criterion as the command value.

With the above configuration (2), if there are a plurality of scheduled change values of the manipulation parameter, one with a larger margin of the other operation index of the plant to the operation criterion is selected as the command value. Accordingly, when the manipulation parameter is controlled to the scheduled change value, the possibility of the other operation index deviating from the operation criterion can be effectively reduced.

(3) In some embodiments, in the above configuration (1), the manipulated variable change unit is configured to, if the operation index is a specific operation index, select, from among two scheduled change values with different change amounts from the current value of the one or more manipulation parameters, a scheduled change value with a larger margin to the operation criterion as the command value.

With the above configuration (3), when searching for a command value for a specific operation index among multiple operation indexes regarding the plant (e.g., an operation index that is highly sensitive to the manipulation parameter and is likely to exceed the operation index when the manipulation parameter changes based on disturbance factors or prediction errors), a scheduled change value with a larger margin is selected as the command value, so that the possibility of the operation index deviating from the operation criterion can be effectively reduced.

(4) In some embodiments, in any one of the above configurations (1) to (3), the manipulated variable change unit is configured to output as the command value the scheduled change value of two or more manipulation parameters for which it has been confirmed that the first predicted value and the second predicted value meet the operation criterion.

With the above configuration (4), by determining the scheduled change values for each of the plurality of manipulation parameters in the same way, even when the command values corresponding to the plurality of manipulation parameters are output to the plant, the possibility of the operation index deviating from the operation criterion can be reduced, and robust plant control against disturbance factors and prediction errors can be achieved.

(5) In some embodiments, in the above configuration (4), the two or more manipulation parameters are selected from among the plurality of manipulation parameters in descending order of contribution to a predicted value of the operation index by the prediction model.

With the above configuration (5), among the manipulation parameters related to the plant, one with high contribution to the predicted value of operation index are preferentially selected as the control target. Accordingly, if the operation index deviates from the operation criterion, the operating state can be accurately controlled so that the operation index meets the operation criterion by outputting the scheduled change value corresponding to this manipulation parameter as the command value.

(6) In some embodiments, in any one of the above configurations (1) to (5), the prediction model is configured to output a probability distribution defined by mean value and variance of a predicted value of the operation index. The first judgement unit and the second judgement unit are configured to, if a combination of the first predicted value and the second predicted value corresponding to a first variance value in the probability distribution meeting the operation criterion cannot be found, judge whether the first predicted value and the second predicted value corresponding to a second variance smaller than the first variance meet the operation criterion.

With the above configuration (6), in the case of using the prediction model that calculates the predicted value as a probability distribution defined by mean and variance values, the variance value of the predicted value is set to a relatively large first variance value, and it is judged whether a combination of the first and second predicted values that meet the operation criterion can be found. As a result, if a combination of the first and second predicted values that meet the operation criterion cannot be found, the variance value of the predicted value is decreased to a second variance value, and it is judged whether a combination of the first and second predicted values that meet the operation criterion can be found. By searching for a combination of the first and second predicted values that meet the operation criterion while decreasing the variance value in this way, an appropriate scheduled change value can be determined and output as the command value.

(7) In some embodiments, in the above configuration (6), the prediction model is configured to output a probability distribution defined by mean value and variance of a predicted value of the operation index, and the first judgement unit and the second judgement unit are configured to, if a combination of the first predicted value and the second predicted value corresponding to at least one of the first variance value or the second variance value in the probability distribution meeting the operation criterion cannot be found, judge whether the first predicted value and the second predicted value corresponding to the mean value meet the operation criterion.

With the above configuration (7), in the case of using the prediction model that calculates the predicted value as a probability distribution defined by mean and variance values, if it is judged that the combination of the first and second predicted values considering the variance values does not meet the operation criterion, then it is judged whether the combination of the first and second predicted values based on the mean value meets the operation criterion.

(8) in some embodiments, in any one of the above configurations (1) to (7), the manipulated variable change unit is configured to set the scheduled change value to half of a change amount from the current value of the one or more manipulation parameters to the virtual change value corresponding to the second predicted value.

With the above configuration (8), the scheduled change value is set to half of a change amount from the current value of the manipulation parameter to the virtual change value. Accordingly, the scheduled change value with the largest margin can be selected as the command value for the range from the current value to the virtual change value where the operation index meets the operation criterion.

If the manipulation parameter can be changed stepwise by limiting the parameter to a value expressed by an integer multiple of the reference change amount ΔP, and if there is a fraction in half of the change amount of the manipulation parameter, the fraction may be rounded down or up as necessary (the one with the larger margin may be selected).

(9) in some embodiments, in any one of the above configurations (1) to (8), the first judgement unit is configured to judge whether the first predicted value corresponding to each of two or more scheduled change values with change amounts from the current value of the one or more manipulation parameters being represented by an integral multiple of a reference change amount ΔP meets the operation criterion. The second judgement unit is configured to judge whether the second predicted value corresponding to each virtual change value with a change amount from the current value of the one or more manipulation parameters being represented by an integral multiple of the reference change amount ΔP meets the operation criterion.

With the above configuration (9), each of the scheduled change value and the virtual change value is represented by an integral multiple of a reference change amount ΔP (i.e., set stepwise). Even under such constraints, with the above configuration, the possibility of the operation index deviating from the operation criterion can be reduced, and robust plant control against disturbance factors and prediction errors can be achieved.

(10) In some embodiments, in the above configuration (9), the first judgement unit is configured to judge whether the first predicted value corresponding to each scheduled change value with a change amount from the current value of the one or more manipulation parameters being represented by ΔP, 2ΔP, . . . , ΔP×M/2, where M is an even number, meets the operation criterion. The second judgement unit is configured to judge whether the second predicted value corresponding to each virtual change value with a change amount from the current value of the one or more manipulation parameters being represented by ΔP×(M/2+1), ΔP×(M/2+2), . . . , ΔP×M meets the operation criterion.

With the above configuration (10), it is judged whether the first and second predicted values meet the operation criterion at each point (ΔP, 2ΔP, . . . , ΔP×M) from the current value of the manipulation parameter to the virtual change value. If the first predicted value and the second predicted value meet the operation criterion at any point, the scheduled change value corresponding to the first predicted value is output as the command value. Thus, the possibility of the operation index deviating from the operation criterion can be more accurately reduced.

(11) In some embodiments, in the above configuration (10), the manipulated variable change unit is configured to output as the command value the scheduled change value with the change amount represented by ΔP×N/2, where N is equal to or smaller than M and is the largest even number such that the first predicted value or the second predicted value corresponding to each of all change amounts that are equal to or smaller than (N×ΔP) meets the operation criterion.

With the above configuration (11), in the range where the predicted value corresponding to the manipulation parameter meets the operation criterion, the scheduled change value corresponding to half of this range is output as the command value. Thus, since the large scheduled change value can be set as the command value based on the range where the predicted value meets the operation criterion, plant control with excellent responsiveness can be performed.

(12) In some embodiments, in any one of the above configurations (1) to (11), the first judgement unit and the second judgement unit are configured to, if a combination of the first predicted value and the second predicted value such that the manipulation parameter meets the operation criterion cannot be found, judge whether the first predicted value and the second predicted value corresponding to the other manipulation parameter included in the explanation variable meet the operation criterion.

With the above configuration (12), if a combination of the first and second predicted values that meet the operation criterion cannot be found for a specific manipulation parameter selected from the plurality of manipulation parameters related to the plant, a search for a combination of the first and second predicted values that meet the operation criterion is performed for the other manipulation parameters.

(13) in some embodiments, in any one of the above configurations (1) to (12), the manipulated variable change unit is configured to output as the command value the scheduled change value for which it has been confirmed that the first predicted value and the second predicted value meet the operation criterion if at least one of the following cases (A) to (C) is satisfied:

(A) a signal indicating occurrence of abnormality of the plant is acquired;

(B) a degree of deviation for an operating point with the largest margin to the operation criterion exceeds a reference value; or

(C) a future value of the operation index predicted from a change schedule of the explanatory variable in the prediction model do not meet the operation criterion.

With the above configuration (13), in the case (A), when abnormality is detected at the current plant operating point, control can be implemented to eliminate the abnormality by outputting the scheduled change value as the command value to the plant. In the case (B), when the current plant operating point deviates from an operating point (optimum operating point) with the largest margin to the operation criterion, the operating point can be shifted to an appropriate operating point by outputting the scheduled change value as the command value to the plant. In the case (C), when it is predicted that the operation index will not meet the operation criterion in the future based on the change schedule of the explanatory variable, possible future abnormality can be avoided by outputting the scheduled change value as the command value to the plant.

(14) To solve the above problem, a plant control system according to at least one embodiment of the present invention comprises: the operating condition determination device having any one of the above configurations (1) to (13), and a control device configured to control a final control element of the plant, based on the command value input from the manipulated variable change unit.

With the above configuration (14), a final control element of the plant is controlled based on the command value output from the operating condition determination device. Since the command value is the scheduled change value that has been confirmed that the operation index meets the operation criterion until the virtual change value with a change amount greater than the scheduled change value, even if the manipulation parameter is affected by disturbance factors or prediction errors when it is changed from the current value to the scheduled change value, the possibility of the operation index deviating from the operation criterion can be effectively reduced. As a result, robust plant control against disturbance factors and prediction errors can be achieved.

(15) To solve the above problem, a program according to at least one embodiment of the present invention for determining a plant operating condition is configured to cause a computer to execute: a step of judging whether a first predicted value of an operation index meets an operation criterion of a plant, the first predicted value being obtained by inputting a scheduled change value of one or more manipulation parameters to a prediction model showing a correlation between the operation index of the plant and an explanatory variable including a plurality of manipulation parameters of the plant; a step of judging whether a second predicted value of the operation index meets the operation criterion of the plant, the second predicted value being obtained by inputting a virtual change value of the one or more manipulation parameters to the prediction model, wherein a change amount of the virtual change value from a current value of the one or more manipulation parameters is greater than that of the scheduled change value; and a step of outputting the scheduled change value as a command value of the one or more manipulation parameters if the first predicted value and the second predicted value meet the operation criterion.

With the above program (15), the first predicted value corresponding to the scheduled change value of the manipulation parameter and the second predicted value corresponding to the virtual change value with a change amount greater than the scheduled change value are calculated by the prediction model and judged whether to meet the operation criterion. If both the first predicted value and the second predicted value meet the operation criterion, the scheduled change value corresponding to the first predicted value is output as the command value. Thus, it is confirmed that the operation index meets the operation criterion until the virtual change value with a change amount greater than the scheduled change value. Therefore, even if the manipulation parameter is affected by disturbance factors or prediction errors when it is changed from the current value to the scheduled change value, the possibility of the operation index deviating from the operation criterion can be effectively reduced.

(16) To solve the above problem, a plant operating condition determination method according to at least one embodiment of the present invention comprises: a step of judging whether a first predicted value of an operation index meets an operation criterion of a plant, the first predicted value being obtained by inputting a scheduled change value of one or more manipulation parameters to a prediction model showing a correlation between the operation index of the plant and an explanatory variable including a plurality of manipulation parameters of the plant; a step of judging whether a second predicted value of the operation index meets the operation criterion of the plant, the second predicted value being obtained by inputting a virtual change value of the one or more manipulation parameters to the prediction model, wherein a change amount of the virtual change value from a current value of the one or more manipulation parameters is greater than that of the scheduled change value; and a step of outputting the scheduled change value as a command value of the one or more manipulation parameters if the first predicted value and the second predicted value meet the operation criterion.

With the above method (16), the first predicted value corresponding to the scheduled change value of the manipulation parameter and the second predicted value corresponding to the virtual change value with a change amount greater than the scheduled change value are calculated by the prediction model and judged whether to meet the operation criterion. If both the first predicted value and the second predicted value meet the operation criterion, the scheduled change value corresponding to the first predicted value is output as the command value. Thus, it is confirmed that the operation index meets the operation criterion until the virtual change value with a change amount greater than the scheduled change value. Therefore, even if the manipulation parameter is affected by disturbance factors or prediction errors when it is changed from the current value to the scheduled change value, the possibility of the operation index deviating from the operation criterion can be effectively reduced.

### Advantageous Effects

At least one embodiment of the present invention provides a plant operating condition determination device, a plant control system, an operating condition determination method and program whereby it is possible to perform robust plant control against disturbance factors and prediction errors using a prediction model.

### BRIEF DESCRIPTION OF DRAWINGS

FIG. 1 is a block diagram showing a functional configuration of a control system of a plant according to at least one embodiment of the present invention.

FIG. 2A is a schematic configuration diagram showing a hardware configuration of the control system of FIG. 1.

FIG. 2B is a schematic configuration diagram showing a hardware configuration of the control system of FIG. 1.

FIG. 3 is a flowchart of an operating condition determination method according to at least one embodiment of the present invention.

FIG. 4 is an operating point transition diagram of the plant corresponding to FIG. 3.

FIG. 5 is an operating point transition diagram of the plant according to another embodiment.

FIG. 6 is an operating point transition diagram of the plant according to another embodiment.

FIG. 7 is a flowchart of an operating condition determination method according to another embodiment.

FIG. 8 is an example of assigning priority to a plurality of manipulation parameters related to the plant.

FIG. 9 is an operating point transition diagram of the plant according to another embodiment.

FIG. 10 is an operating point transition diagram of the plant according to another embodiment.

FIG. 11 is an operating point transition diagram of the plant according to another embodiment.

FIG. 12 is a block diagram showing a functional configuration of the control system of the plant according to another embodiment.

FIG. 13 is a block diagram showing a functional configuration of the control system of the plant according to another embodiment.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

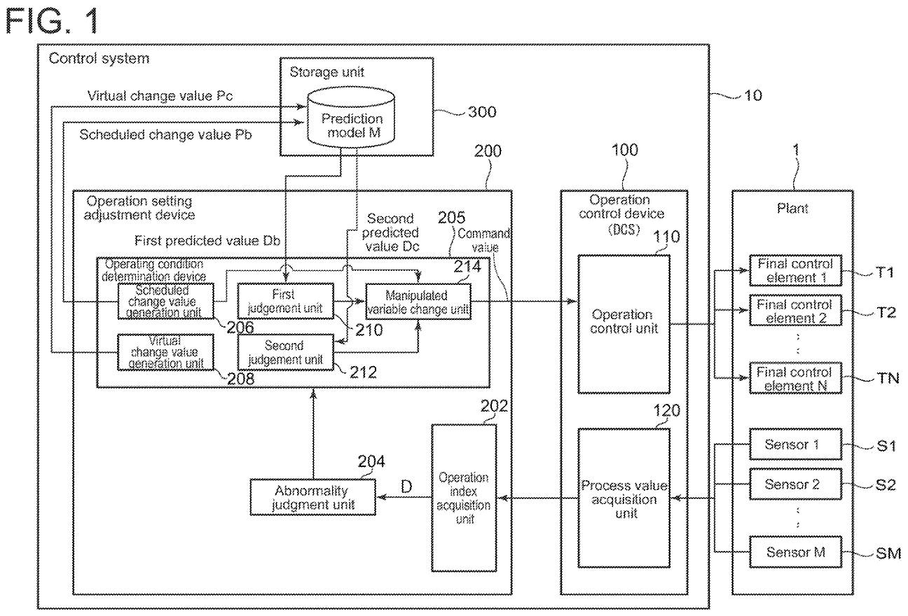

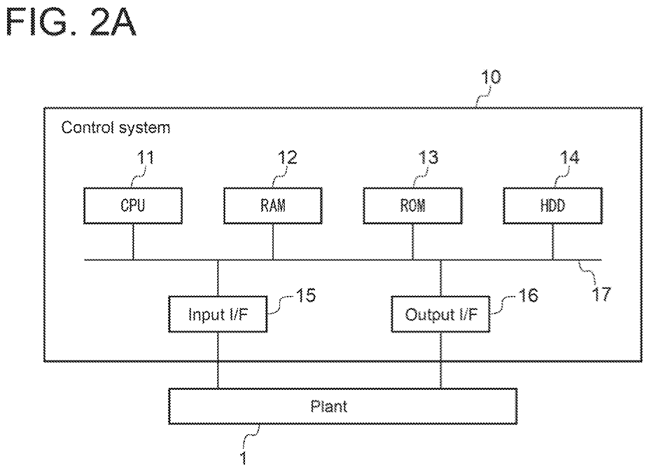

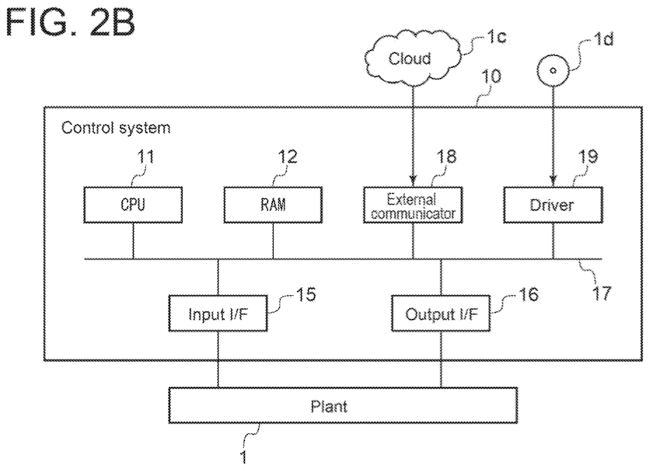

FIG. 1 is a block diagram showing a functional configuration of a control system 10 of a plant 1 according to at least one embodiment of the present invention. FIGS. 2A and 2B are each a schematic configuration diagram showing a hardware configuration of the control system 10 of FIG. 1.

As shown in FIG. 1, the plant to be controlled includes one or more final control elements T1 to TN (N is an integer of 1 or more). By operating the final control elements T1 to TN based on control signals input from the control system 10, the operating state of the plant 1 is controlled. The operating state of the plant 1 is monitored by one or more sensors S1 to SM (M is an integer of 1 or more) installed in the plant 1, and detected values by the sensors S1 to SM (M is an integer of 1 or more) are input in the control system 10 and used as information for determining the operating condition of the plant 1.

As shown in FIGS. 2A and 2B, the control system 10 may be configured by a computer. Specifically, as shown in FIG. 2A, the control system 10 may include a central processing unit (CPU) 11, a random access memory (RAM) 12, a read only memory (ROM) 13, a hard disk drive (HDD) 14, an input I/F 15, and an output I/F 16, which are connected via a bus 17.

The hardware configuration of the control system 10 is not limited thereto, and may be configured by a combination of a control circuit and a storage device.

As shown in FIG. 2B, a program for implementing a function of the control system 10 (operating condition determination program) may be stored in a cloud 1c or a storage medium 1d. The control system 10 may be equipped with an external communicator 18, such as a 4G or 5G line communicator or a wireless LAN communicator such as Wi-Fi (registered trademark), and the CPU 11 may read the program from the cloud 1c via the external communicator 18, load it into the RAM 12, and execute it. The control system 10 may be equipped with a driver 19 for reading data from the storage medium 1d, and the CPU 11 may read the program from the storage medium 1d, load it into the RAM 12, and execute it. Any type of storage medium 1d can be used, for example, SD card, USB memory, external HDD, and various other storage media 1d according to the size of the program.

In the embodiment shown in FIG. 1, the control system 10 includes an operation control device 100, an operation setting adjustment device 200, and a storage unit 300.

The operation control device 100 includes an operation control unit 110 and a process value acquisition unit 120. The operation control unit 110 is a unit for performing control of the plant 1 by transmitting a control signal to the plant 1. In the operation control unit 110, a control signal based on a command value input from the operation setting adjustment device 200, which will be described below, is generated, and the control signal is transmitted to each of the final control elements T1 to TN of the plant 1. In the process value acquisition unit 120, process values detected by the sensors S1 to SM installed in the plant 1 are acquired and transmitted to the operation setting adjustment device 200.

The operation setting adjustment device 200 outputs a command value to the operation control device 100 to adjust the operation setting of the plant 1. To realize this function, the operation setting adjustment device 200 includes an operation index acquisition unit 202, an abnormality judgement unit 204, and an operating condition determination device 205.

The operation index acquisition unit 202 acquires an operation index D based on the process values input from the process value acquisition unit 120. The operation index D is a parameter related to the operating state of the plant 1 and may be a process value measured by a sensor or a calculated value calculated based on the process value.

The abnormality judgement unit 204 judges whether there is an abnormality in the plant 1 based on the operation index D input from the operation index acquisition unit 202. Specifically, the abnormality judgement unit 204 judges the presence or absence of abnormality in the plant 1 by comparing the operation index D input from the operation index acquisition unit 202 with an operation criterion Dref previously prepared. The operation criterion Dref is prepared for each type of operation index D.

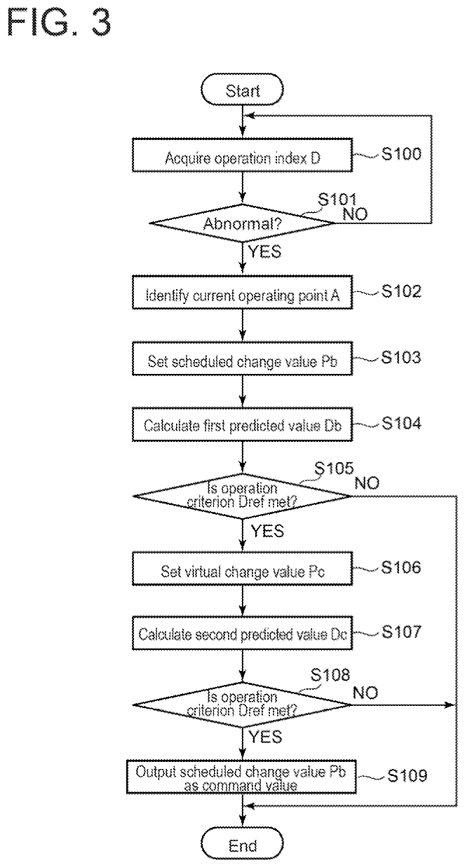

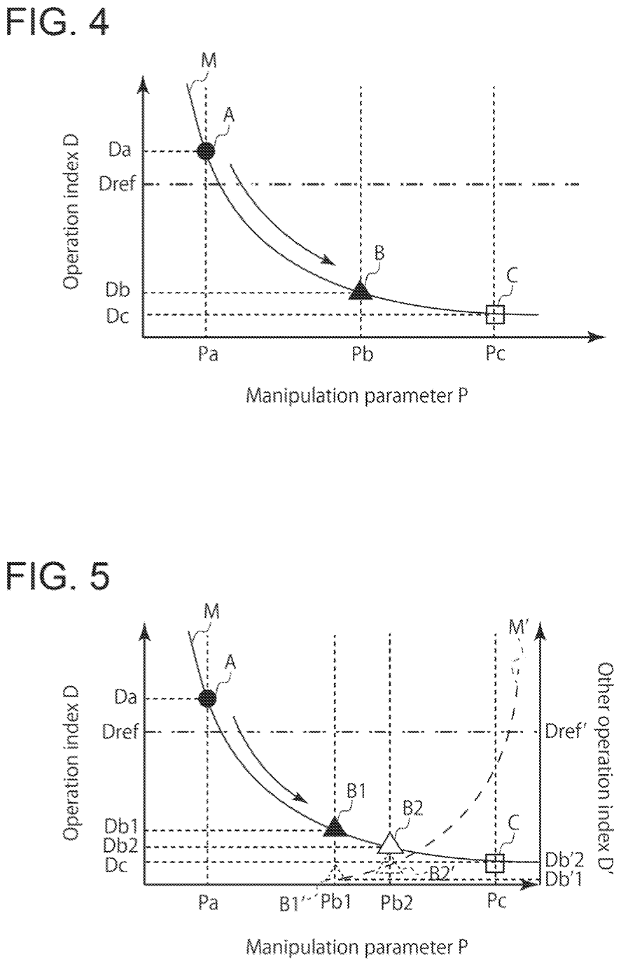

The judgement result of the abnormality judgement unit 204 is input to the operating condition determination device 205, and the operating condition determination device 205 starts determining the operating condition upon input of the abnormality judgement (i.e., if no abnormality judgement is input, the operating condition determination device 205 does not determine a new operating condition, and the previous operating condition is maintained). The operating condition determination device 205 includes a scheduled change value generation unit 206, a virtual change value generation unit 208, a first judgement unit 210, a second judgement unit 212, and a manipulated variable change unit 214. Details of these components of the operating condition determination device 205 will be described later with reference to FIGS. 3 and 4.

The storage unit 300 is a device capable of storing various information necessary for the operating condition determination method implemented by the operating condition determination device 205. In the present embodiment, a prediction model M is stored in the storage unit 300 in advance. The prediction model M is a physical or statistical model that specifies a correlation between manipulation parameter P of the plant 1 and predicted value of the operation index D. For example, it is constructed by using the statistical machine learning method or neural network method.

The storage unit 300 may be configured as the HDD 14 (hard disk drive) as described above with reference to FIG. 2A, or as the cloud 1c or the storage medium 1d as described above with reference to FIG. 2B.

Next, the operating condition determination method implemented by the operating condition determination device 205 with the above configuration will be described. FIG. 3 is a flowchart of the operating condition determination method according to at least one embodiment of the present invention. FIG. 4 is an operating point transition diagram of the plant 1 corresponding to FIG. 3.

First, the operation index acquisition unit 202 acquires an operation index D of the plant 1 (step S100). Specifically, the operation index acquisition unit 202 acquires a process value detected from the plant 1 by the process value acquisition unit 120 of the operation control device 100, and calculates the operation index D based on the process value. The operation index D may be a process value as it is, or a calculated value calculated based on the process value.

Then, the abnormality judgement unit 204 judges whether there is an abnormality in the plant 1 based on the operation index D acquired in step S100 (step S101). The abnormality judgement in step S101 is performed by, for instance, comparing the operation index D with an operation criterion Dref previously set. The operation criterion Dref may be set previously by an experimental method, or may be set by a simulation method, or may be set by considering past operation results. The abnormality judgement unit 204 continuously performs abnormality judgement by monitoring the operation index D during operation of the plant 1.

If the abnormality judgement unit 204 judges that there is an abnormality (step S101: YES), the operating condition determination device 205 identifies a current operating point A of the plant 1 (step S102). The current operating point A is identified based on, for example, a process value detected from the plant 1 by the process value acquisition unit 120 of the operation control device 100. In FIG. 4, the current operating point A has an operation index Da that exceeds the operation criterion Dref, indicating that there is an abnormality in the plant 1.

Then, the scheduled change value generation unit 206 generates a scheduled change value Pb based on the current operating point A acquired in step S102 (step S103). The scheduled change value Pb is a manipulation parameter corresponding to an operating point B which is the control target. In other words, the scheduled change value Pb is generated by adding a predetermined manipulated variable to a manipulation parameter Pa corresponding to the current operating point A.

Then, the first judgement unit 210 calculates a first predicted value Db, which is an operation index corresponding to the scheduled change value Pb generated in step S103 (step S104), and judges whether the first predicted value Db meets the operation criterion Dref (step S105). The calculation of the first predicted value Db is performed by inputting the scheduled change value Pb generated in step S103 to the prediction model M stored in advance in the storage unit 30). FIG. 4 shows the case where the first predicted value Db is less than the operation criterion Dref (step S105: YES).

Then, the virtual change value generation unit 208 generates a virtual change value Pc based on the current operating point A acquired in step S102 (step S106). The virtual change value Pc is generated as a manipulation parameter with a change amount from the manipulation parameter Pa corresponding to the current operating point A greater than that of the scheduled change value Pb.

Then, the second judgement unit 212 calculates a second predicted value Dc, which is an operation index corresponding to the virtual change value Pc generated in step S106 (step S107), and judges whether the second predicted value Dc meets the operation criterion Dref (step S108). The calculation of the second predicted value Dc is performed by inputting the virtual change value Pc generated in step S106 to the prediction model M stored in advance in the storage unit 300. FIG. 4 shows the case where the second predicted value Dc is less than the operation criterion Dref (step S108: YES).

If the first judgement unit 210 and the second judgement unit judge that the first predicted value Db and the second predicted value De meet the operation criterion Dref (step S105: YES, step S108: YES), the manipulated variable change unit 214 outputs the scheduled change value Pb as the command value of the manipulation parameter P to the operation control unit 110 (step S109). The virtual change value Pc is a virtual value set to evaluate whether the scheduled change value Pb can be output as the command value, and the virtual change value Pc itself is not used as the command value. Thus, since it is confirmed that the operation index D meets the operation criterion Dref until the virtual change value Pc with a greater change amount than the scheduled change value Pb, even if the manipulation parameter P is affected by disturbance factors or prediction errors when it is changed from the current value to the scheduled change value Pb, the plant can be controlled so as to effectively reduce the possibility of the operation index D deviating from the operation criterion Dref.

Although the flowchart in FIG. 3 shows the case where the judgement by the first judgement unit 210 is performed before the judgement by the second judgement unit 212, the judgement by the first judgement unit 210 may be performed after the judgement by the second judgement unit 212, or the judgement by the first judgement unit 210 and the second judgement unit 212 may be performed simultaneously.

In some embodiments, the scheduled change value generation unit 206 may generate two scheduled change values with different change amounts, and the manipulated variable change unit 214 may select a scheduled change value Db with a larger margin of another operation index of the plant 1 to the operation criterion as the command value.

In the embodiment shown in FIG. 5, the scheduled change value generation unit 206 generates two scheduled change values Pb1, Pb2 with different change amounts. The first predicted value Db1 obtained by inputting the scheduled change value Pb1 to the prediction model M, and the first predicted value Db2 obtained by inputting the scheduled change value Pb2 to the prediction model M both meet the operation criterion Pref (they are less than the operation criterion Pref).

In FIG. 5, in addition to the aforementioned prediction model M, a prediction model M′ corresponding to another operation index D′ of the plant 1 is shown. The other prediction model M′ is a prediction model that specifies a correlation between the explanatory variable common to the prediction model M and another operation index D′. The other prediction model M′ shows a tendency for the other operation index D′ to increase as the manipulation parameter P increases. Therefore, the predicted value Db1′ corresponding to the scheduled change value Pb1 calculated based on the other prediction model M′ is smaller than the predicted value Db2′ corresponding to the scheduled change value Pb2 calculated based on the other prediction model M′. In other words, the scheduled change value Pb1 has a larger margin to the operation criterion Dref than the scheduled change value Pb2. In this case, the manipulated variable change unit 214 selects, from among the two scheduled change value Pb1, Pb2, the scheduled change value Pb1 with the larger margin as the command value. Accordingly, when the manipulation parameter P is controlled to the scheduled change value Pb1, the plant can be controlled so as to effectively reduce the possibility of the other operation index D′ deviating from the operation criterion Dref.

In some embodiments, the manipulated variable change unit 214 may be configured to, if the operation index is a specific operation index, select, from among two scheduled change values Pb1, Pb2 with different change amounts from the current value of one or more manipulation parameters, a scheduled change value with a larger margin to the operation criterion Dref as the command value.

Generally, there is a plurality of operation indexes for the plant, and at least one of these operation indexes can be selected for control as described above. If a specific operation index is selected from these operation indexes, the manipulated variable change unit 214 selects a scheduled change value with a larger margin as the command value. For example, in the case of selecting an operation index that is highly sensitive to the manipulation parameter and is likely to exceed the operation index Dref when the manipulation parameter changes based on disturbance factors or prediction errors, when a scheduled change value with a larger margin is selected as the command value, the possibility of deviating from the operation criterion Dref can be effectively reduced.

In some embodiments, the scheduled change value Pb may be half of the change amount from the manipulation parameter Pa corresponding to the current operating point A to the virtual change value Pc.

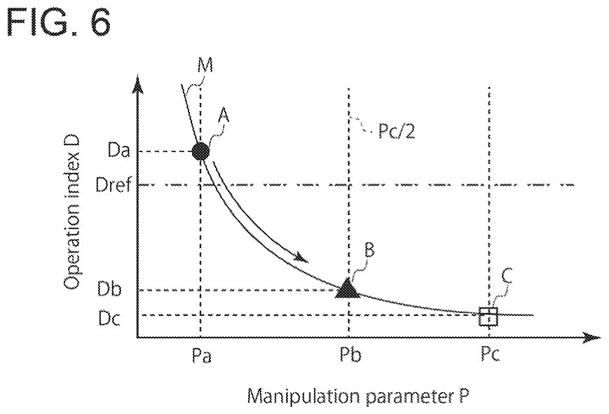

In the embodiment shown in FIG. 6, the scheduled change value generation unit 206 generates a scheduled change values Pb (=Pc/2) which is half of the virtual change value Pc generated by the virtual change value generation unit 208. When the scheduled change value Pb (=Pc/2) and the virtual change value Pc are generated in this way, as in the embodiment described above, the first judgement unit 210 judges whether the first predicted value Db corresponding to the scheduled change value Pb(=Pc/2) meets the operation criterion Dref, and the second judgement unit 212 judges whether the second predicted value Dc corresponding to the virtual change value Pc meets the operation criterion Dref. As a result, if it is judged that the first predicted value Db and the second predicted value Dc meet the operation criterion Dref, the manipulated variable change unit 214 outputs the scheduled change value Pb (=Pc/2) as the command value of the manipulation parameter P to the operation control unit 110. Accordingly, the scheduled change value with the largest margin can be selected as the command value for the range from the current value to the virtual change value where the operation index meets the operation criterion Dref.

If a possible value of the manipulation parameter P is limited stepwise to an integer multiple of the reference change amount ΔP (i.e., if the manipulation parameter P is represented by ΔP×n, where n is an integer of 1 or more), and if the half of the virtual change value Pc includes a fraction, the fraction may be rounded down or up (rounding down or up may be selected according to the larger margin, for example).

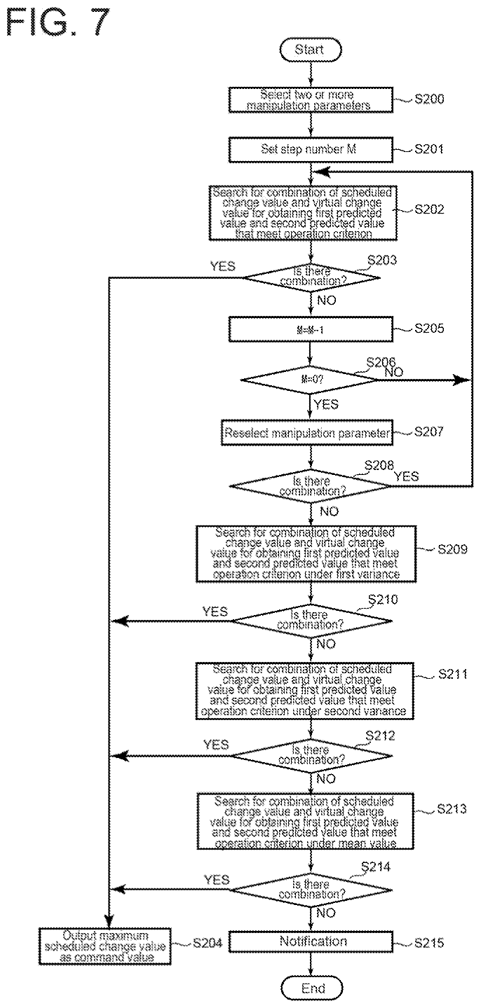

In some embodiments, the command value may be output for two or more manipulation parameters selected from the plurality of manipulation parameters related to the plant 1. FIG. 7 is a flowchart of the operating condition determination method according to another embodiment.

The following is an example of the case where each manipulation parameter P can be changed step by step (stepwise) to an integer multiple of the reference change amount ΔP previously set.

First, two or more manipulation parameters are selected from the plurality of manipulation parameters related to the plant 1 (step S200). The selection in step S200 is performed in descending order of contribution to the predicted value of the operation index by the prediction model M, for example.

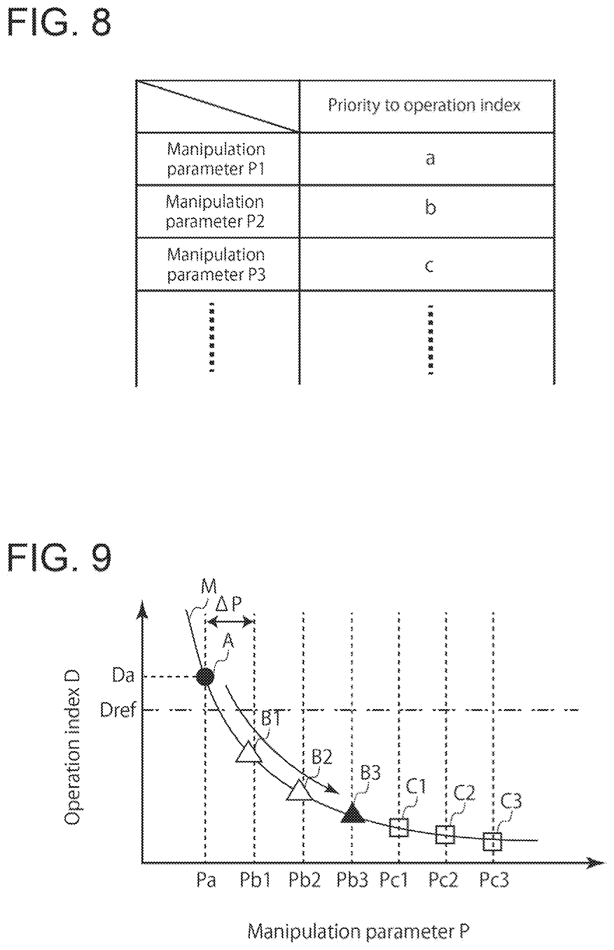

FIG. 8 is an example of assigning priority to the plurality of manipulation parameters related to the plant 1. In FIG. 8, the plurality of manipulation parameters P1, P2, P3, . . . , related to the plant 1 are assigned priorities a, b, c, . . . in order of contribution to a specific operation index D. By selecting the manipulation parameters to be controlled according to priority in step S200, the desired operation index D can be quickly shifted to the target value, and good responsiveness can be obtained. The relationship between each manipulation parameter and priority may be stored in advance in the storage unit 300 as a database, for example, and may be readable as appropriate. For example, if two manipulation parameters are to be selected, the one with the highest contribution and the one with the next highest contribution are selected.

Then, the step number M for defining the calculation range of the scheduled change value Pb and the virtual change value Pc is set (step S201). Here, the step number M is set to any even number equal to or greater than 2.

Then, for the two manipulation parameters selected in step S200, in the range of the step number M set in step S201, a combination of the scheduled change value Pb and the virtual change value Pc where both the first predicted value Db and the second predicted value Dc meet the operation criterion Dref is searched for (step S202). Specifically, the first judgement unit 210 judges whether the first predicted value corresponding to each of the scheduled change values with a change amount from the current value of the manipulation parameter being represented by ΔP, 2ΔP, . . . , ΔP×M/2 meets the operation criterion Dref. Further, the second judgement unit 212 judges whether the second predicted value corresponding to each of the scheduled change values with a change amount from the current value of the manipulation parameter being represented by ΔP×(M/2+1), ΔP×(M/2+2), . . . , ΔP×M meets the operation criterion Dref. By collecting the judgement results of the first judgement unit 210 and the second judgement unit 212, it is judged whether there is a combination of the scheduled change value Pb and the virtual change value Pc where both the first predicted value Db and the second predicted value Dc meet the operation criterion Dref (step S203).

FIG. 9 shows an example where, when the step number is M (=6), the first predicted values Db corresponding to the scheduled change values Pb1 (=ΔP), Pb2 (=2ΔP), and Pb3 (=3ΔP=ΔP×6/2) meet the operation criterion Dref. and the second predicted values Dc corresponding to the virtual change values Pc1 (=4ΔP), Pc2 (=5ΔP), and Pc3 (=6ΔP) meet the operation criterion Dref. If there is a combination of the scheduled change value Pb and the virtual change value Pc where both the first predicted value Db and the second predicted value Dc meet the operation criterion Dref (step S203: YES), the largest scheduled change value Pb3 is output as the command value (step S204).

Conversely, if there is no combination of the scheduled change value Pb and the virtual change value Pc where both the first predicted value Db and the second predicted value Dc meet the operation criterion Dref (step S203: NO), the step number M is decreased by one (step S205). If the decreased step number M is not zero (step S206: NO), the process returns to step S202, and a combination of the scheduled change value Pb and the virtual change value Pc where both the first predicted value Db and the second predicted value Dc meet the operation criterion Dref is searched for in a narrower range.

Conversely, if the decreased step number M is zero (step S206: YES), the manipulation parameter is reselected (step S207). In other words, if an appropriate command value cannot be found with the combination of the manipulation parameter selected in step S200, the selection of the prerequisite manipulation parameter is redone. Specifically, for the manipulation parameters selected in step S200, the manipulation parameters with the next highest contribution to the predicted value of the operation index by the prediction model is selected. For example, if the manipulation parameters with the highest and the second highest contribution are selected in step S200, the manipulation parameters with the highest and the third highest contribution are selected in step S207.

In step S207, if appropriate manipulation parameters can be selected (step S208: YES), the process returns to step S202, and for the reselected two manipulation parameters, a combination of the scheduled change value Pb and the virtual change value Pc where both the first predicted value Db and the second predicted value Dc meet the operation criterion Dref is searched for in the same way. In this way, if an appropriate command value cannot be obtained according to the manipulation parameter with the highest priority, an appropriate command value can be sought by sequentially selecting the manipulation parameter with the next highest priority.

Meanwhile, if appropriate manipulation parameters cannot be selected in step S207 (step S208: NO), a search for a combination considering variance values specified in the prediction model M is performed. First, the first judgement unit 210 and the second judgement unit 212 calculate the first predicted value Db and the second predicted value Dc according to a large first variance value +2σ among the variance values specified in the prediction model M, and search for a combination meeting the operation criterion Dref (step S209). As a result, if a combination where the first predicted value Db and the second predicted value Dc meet the operation criterion Dref is found (step S210: YES), the largest scheduled change value Pb is output as the command value (step S204).

Conversely, if a combination where the first predicted value Db and the second predicted value Dc meet the operation criterion Dref is not found (step S210: NO), the first judgement unit 210 and the second judgement unit 212 calculate the first predicted value Db and the second predicted value Dc according to a second variance value +σ that is smaller than the first variance value +2σ among the variance values specified in the prediction model M, and search for a combination meeting the operation criterion Dref (step S211). As a result, if a combination where the first predicted value Db and the second predicted value Dc meet the operation criterion Dref is found (step S211: YES), the largest scheduled change value Pb is output as the command value (step S204).

In FIG. 10, the first predicted value Db1 calculated according to the first variance value +2σ meets the operation criterion Dref, but the second predicted value Dc1 calculated according to the first variance value +2σ does not meet the operation criterion Dref. Therefore, in such a case, the variance value is decreased to the second variance value +σ, and then it is judged again whether the first predicted value Db and the second predicted value Dc meet the operation criterion Dref. As a result, in FIG. 10, since the first predicted value Db and the second predicted value De calculated according to the second variance value +σ meet the operation criterion Dref, the scheduled change value Pb corresponding to the first predicted value Db is output as the command value. By searching for a combination of the first predicted value Db and the second predicted value Dc that meet the operation criterion Dref while decreasing the variance value specified by the prediction model M in this way, an appropriate scheduled change value Pb can be determined.

Conversely, if a combination where the first predicted value Db and the second predicted value Dc meet the operation criterion Dref is not found based on the second variance value +σ (step S212: NO), the first judgement unit 210 and the second judgement unit 212 calculate the first predicted value Db and the second predicted value Dc according to the mean value specified in the prediction model M. and search for a combination meeting the operation criterion Dref (step S213). As a result, if a combination where the first predicted value Db and the second predicted value Dc meet the operation criterion Dref is found (step S213: YES), the largest scheduled change value Pb is output as the command value (step S204).

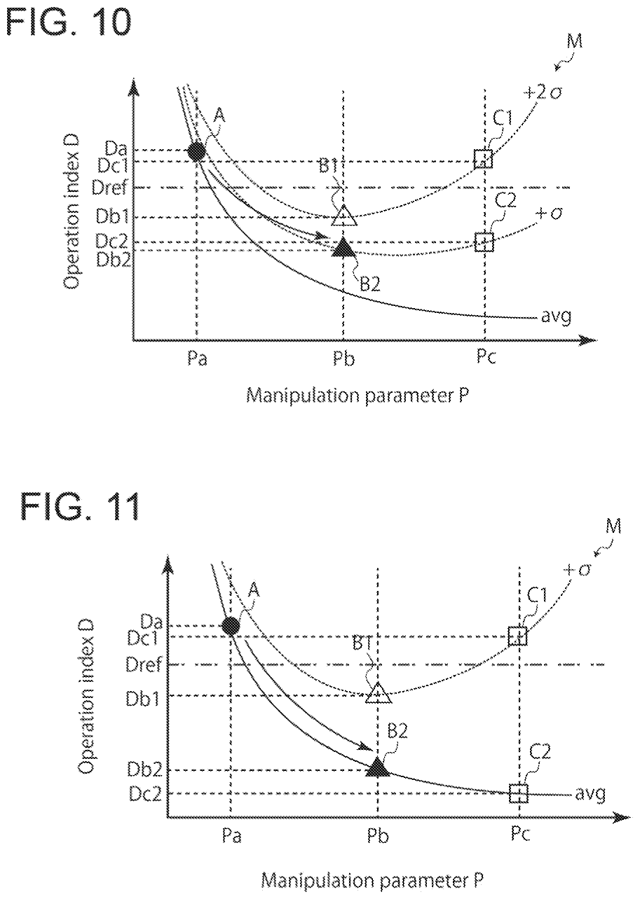

In FIG. 11, the first predicted value Db1 calculated according to the second variance value +σ meets the operation criterion Dref, but the second predicted value Dl calculated according to the second variance value +σ does not meet the operation criterion Dref. Therefore, in such a case, it is judged whether the first predicted value Db2 and the second predicted value Dc2 calculated according to the mean value avg specified in the physical model M meet the operation criterion Dref. As a result, in FIG. 11, since the first predicted value Db and the second predicted value Dc calculated according to the mean value avg meet the operation criterion Dref, the scheduled change value Pb corresponding to the first predicted value Db is output as the command value. In the present embodiment, if a combination of the first predicted value Db1 and the second predicted value Dc1 that meet the operation criterion Dref cannot be found based on the variance values, by searching for a combination of the first predicted value Db2 and the second predicted value Dc2 that meet the operation criterion Dref based on the mean value avg, an appropriate scheduled change value Pb can be determined.

Meanwhile, if a combination where the first predicted value Db and the second predicted value Dc meet the operation criterion Dref is not found based on the mean value avg (step S214: NO), the user is notified that it is difficult to set the command value with a sufficient margin to the operation reference Dref (step S215). In other words, if it is difficult to find an appropriate command value as a result of the search in the above-described steps, a signal to that effect is output.

In the above-described steps, basically, if a combination where the first predicted value Db and the second predicted value Dc meet the operation criterion Dref is found, the largest scheduled change value Pb is uniformly output as the command value (see step S204). However, in other embodiments, for example, if a combination where the first predicted value Db and the second predicted value Dc meet the operation criterion Dref cannot be found based on the first variance value +2σ in step S210 (step S210: NO), but a combination where the first predicted value Db and the second predicted value Dc meet the operation criterion Dref is found in step S212 or S214, the command value may be set smaller than the largest scheduled change value (for example, the command value may be limited to only one step). This is because if an appropriate command value cannot be found with the first variance value +2σ, even if an appropriate command value is found according to the second variance value +σ or the mean value, there is a large possibility that the control will behave differently than expected when it is implemented according to the command value.

Thus, for two or more manipulation parameters selected from among the plurality of manipulation parameters of the plant 1, by searching for a combination where the first predicted value Db and the second predicted value Dc meet the operating criterion Dref, the command value can be determined. By performing control according to this command value, robust plant control against disturbance factors and prediction errors can be achieved.

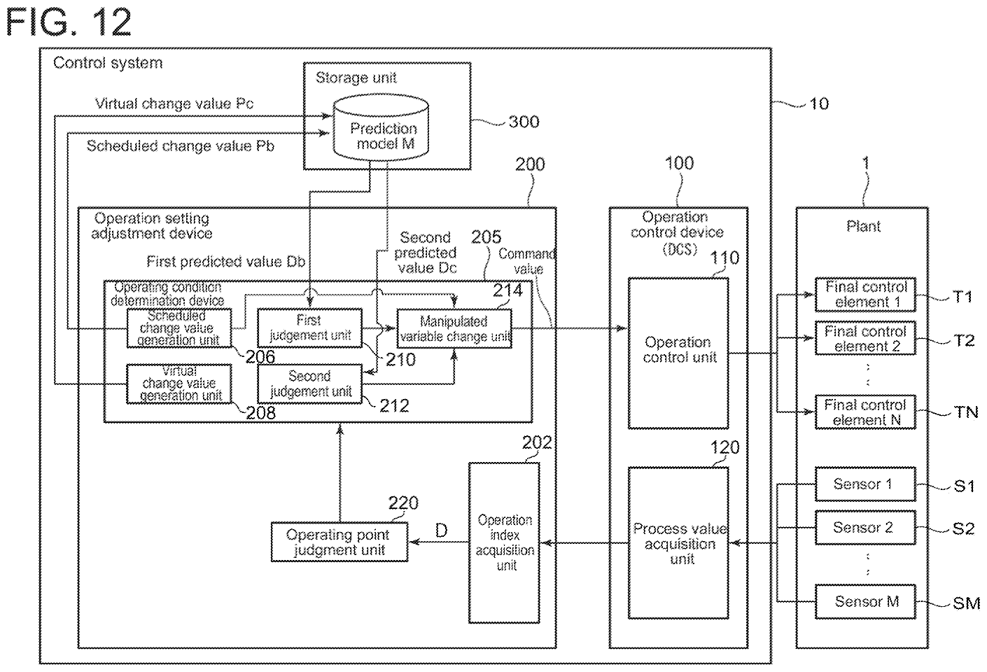

FIG. 12 is a block diagram showing a functional configuration of the control system 10 of the plant 1 according to another embodiment. In the embodiment shown in FIG. 12, the operation setting adjustment device 200 includes an operating point judgement unit 220 instead of the abnormality judgement unit 204 in FIG. 1. The operating point judgement unit 220 judges whether the degree of deviation of the current operating point of the plant 1 from the optimum operating point exceeds a reference value. Specifically, the operating point judgement unit 220 identifies the current operating point by acquiring the operation index D from the operation index acquisition unit 202, identifies the optimum operating point where the operation index D is the optimum value, and evaluates the degree of deviation between them.

The judgement result of the operating point judgement unit 220 is input to the operating condition determination device 205, and if it is judged by the operating point judgement unit 220 that the degree of deviation is equal to or more than a judgement threshold, the operating condition determination device 205 starts determining the operating condition (i.e., if the degree of deviation is less than the judgement threshold, the operating condition determination device 205 does not determine a new operating condition, and the previous operating condition is maintained). The specific control by the operating condition determination device 205 is the same as in the above-described embodiments.

In the present embodiment, when the current operating point of the plant 1 deviates from the optimum operating point, the operating point can be shifted to an appropriate operating point by outputting the scheduled change value Pb as the command value to the plant 1.

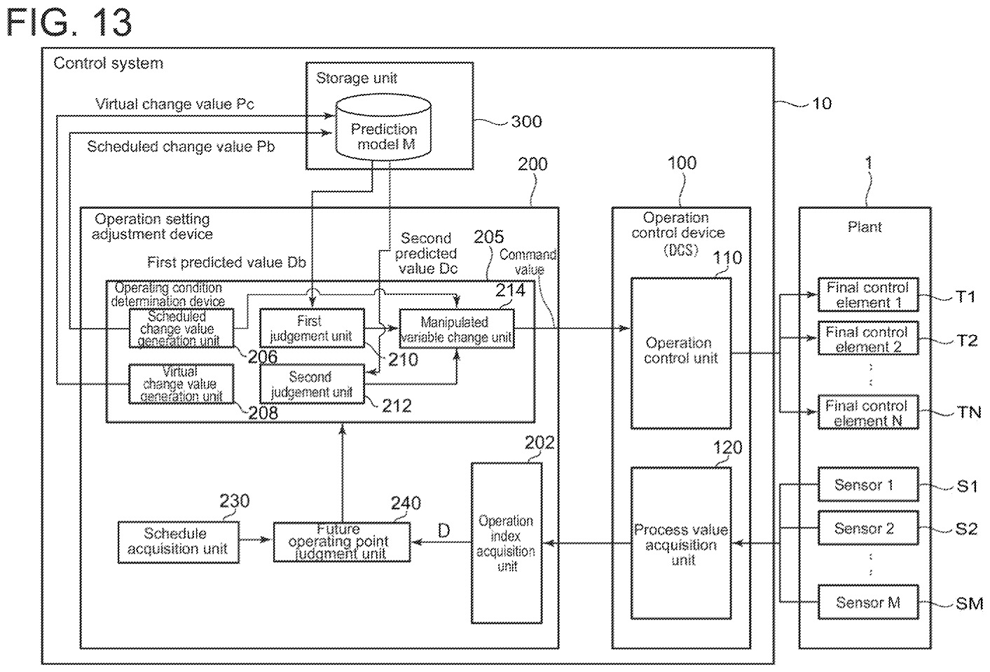

FIG. 13 is a block diagram showing a functional configuration of the control system 10 of the plant 1 according to another embodiment. In the embodiment shown in FIG. 13, the operation setting adjustment device 200 includes a schedule acquisition unit 230 and a future operating point judgement unit 240 instead of the abnormality judgement unit 204 in FIG. 1. The schedule acquisition unit 230 acquires schedule information that defines future time changes regarding manipulation parameters of the explanatory variable of the prediction model M. The future operating point judgement unit 240 identifies a future operation index by calculating the predicted value of the operation index corresponding to the schedule information using the prediction model M upon input of the schedule information from the schedule acquisition unit 230. The future operating point judgement unit 240 then compares the future operation index with the operation criterion to judge whether the operation index is expected to fail to meet the operation criterion in the future.

The judgement result of the future operating point judgement unit 240 is input to the operating condition determination device 205, and if it is judged by the future operating point judgement unit 240 that the operation index is expected to fail to meet the operation criterion in the future, the operating condition determination device 205 starts determining the operating condition (i.e., if the operation index is expected to meet the operation criterion in the future, the operating condition determination device 205 does not determine a new operating condition, and the previous operating condition is maintained). The specific control by the operating condition determination device 205 is the same as in the above-described embodiments.

Thus, in the present embodiment, when it is predicted that the operation index will not meet the operation criterion in the future based on the change schedule of the explanatory variable, possible future abnormality can be avoided by outputting the scheduled change value as the command value to the plant 1.

Each of the above-described embodiments provides the operating condition determination device for the plant 1, the plant control system, the operating condition determination method and program whereby it is possible to perform robust plant control against disturbance factors and prediction errors using the prediction model M.

The present invention is not limited to the embodiments described above, but includes modifications to the embodiments described above, and embodiments composed of combinations of those embodiments.

### INDUSTRIAL APPLICABILITY

At least one embodiment of the present invention can be applied to a plant operating condition determination device, a plant control device, an operating condition determination method and program.

### REFERENCE SIGNS LIST

1 Plant
10 Control system
11 CPU
17 Bus
18 External communicator
19 Driver
100 Operation control device
110 Operation control unit
120 Process value acquisition unit
200 Operation setting adjustment device
202 Operation index acquisition unit
204 Abnormality judgement unit
205 Operating condition determination device
206 Scheduled change value generation unit
208 Virtual change value generation unit
210 First judgement unit
212 Second judgement unit
214 Manipulated variable change unit
220 Operating point judgement unit
230 Schedule acquisition unit
240 Future operating point judgement unit
300 Storage unit

1. A plant operating condition determination device, comprising:
a first judgement unit configured to judge whether a first predicted value of an operation index meets an operation criterion of a plant, the first predicted value being obtained by inputting a scheduled change value of one or more manipulation parameters to a prediction model showing a correlation between the operation index of the plant and an explanatory variable including a plurality of manipulation parameters of the plant;
a second judgement unit configured to judge whether a second predicted value of the operation index meets the operation criterion of the plant, the second predicted value being obtained by inputting a virtual change value of the one or more manipulation parameters to the prediction model, wherein a change amount of the virtual change value from a current value of the one or more manipulation parameters is greater than that of the scheduled change value; and
a manipulated variable change unit configured to output the scheduled change value as a command value of the one or more manipulation parameters if the first judgement unit and the second judgement unit judge that the first predicted value and the second predicted value meet the operation criterion.

2. The plant operating condition determination device according to claim 1,
wherein the manipulated variable change unit is configured to select, from among two scheduled change values with different change amounts from the current value of the one or more manipulation parameters, a scheduled change value with a larger margin of another operation index of the plant to the operation criterion as the command value.

3. The plant operating condition determination device according to claim 1,
wherein the manipulated variable change unit is configured to, if the operation index is a specific operation index, select, from among two scheduled change values with different change amounts from the current value of the one or more manipulation parameters, a scheduled change value with a larger margin to the operation criterion as the command value.

4. The plant operating condition determination device according to claim 1,
wherein the manipulated variable change unit is configured to output as the command value the scheduled change value of two or more manipulation parameters for which it has been confirmed that the first predicted value and the second predicted value meet the operation criterion.

5. The plant operating condition determination device according to claim 4,
wherein the two or more manipulation parameters are selected from among the plurality of manipulation parameters in descending order of contribution to a predicted value of the operation index by the prediction model.

6. The plant operating condition determination device according to claim 1,
wherein the prediction model is configured to output a probability distribution defined by mean value and variance of a predicted value of the operation index, and
wherein the first judgement unit and the second judgement unit are configured to, if a combination of the first predicted value and the second predicted value corresponding to a first variance value in the probability distribution meeting the operation criterion cannot be found, judge whether the first predicted value and the second predicted value corresponding to a second variance smaller than the first variance meet the operation criterion.

7. The plant operating condition determination device according to claim 6,
wherein the prediction model is configured to output a probability distribution defined by mean value and variance of a predicted value of the operation index, and
wherein the first judgement unit and the second judgement unit are configured to, if a combination of the first predicted value and the second predicted value corresponding to at least one of the first variance value or the second variance value in the probability distribution meeting the operation criterion cannot be found, judge whether the first predicted value and the second predicted value corresponding to the mean value meet the operation criterion.

8. The plant operating condition determination device according to claim 1,
wherein the manipulated variable change unit is configured to set the scheduled change value to half of a change amount from the current value of the one or more manipulation parameters to the virtual change value corresponding to the second predicted value.

9. The plant operating condition determination device according to claim 1,
wherein the first judgement unit is configured to judge whether the first predicted value corresponding to each of two or more scheduled change values with change amounts from the current value of the one or more manipulation parameters being represented by an integral multiple of a reference change amount ΔP meets the operation criterion, and
wherein the second judgement unit is configured to judge whether the second predicted value corresponding to each virtual change value with a change amount from the current value of the one or more manipulation parameters being represented by an integral multiple of the reference change amount ΔP meets the operation criterion.

10. The plant operating condition determination device according to claim 9,
wherein the first judgement unit is configured to judge whether the first predicted value corresponding to each scheduled change value with a change amount from the current value of the one or more manipulation parameters being represented by ΔP, 2ΔP, . . . , ΔP×M/2, where M is an even number, meets the operation criterion, and
wherein the second judgement unit is configured to judge whether the second predicted value corresponding to each virtual change value with a change amount from the current value of the one or more manipulation parameters being represented by ΔP×(M/2+1), ΔP×(M/2+2), . . . , ΔP×M meets the operation criterion.

11. The plant operating condition determination device according to claim 10,
wherein the manipulated variable change unit is configured to output as the command value the scheduled change value with the change amount represented by ΔP×N/2, where N is equal to or smaller than M and is the largest even number such that the first predicted value or the second predicted value corresponding to each of all change amounts that are equal to or smaller than (N×ΔP) meets the operation criterion.

12. The plant operating condition determination device according to claim 1,
wherein the first judgement unit and the second judgement unit are configured to, if a combination of the first predicted value and the second predicted value such that the manipulation parameter meets the operation criterion cannot be found, judge whether the first predicted value and the second predicted value corresponding to the other manipulation parameter included in the explanation variable meet the operation criterion.

13. The plant operating condition determination device according to claim 1,
wherein the manipulated variable change unit is configured to output as the command value the scheduled change value for which it has been confirmed that the first predicted value and the second predicted value meet the operation criterion if at least one of the following cases (A) to (C) is satisfied:
(A) a signal indicating occurrence of abnormality of the plant is acquired;
(B) a degree of deviation for an operating point with the largest margin to the operation criterion exceeds a reference value; or
(C) a future value of the operation index predicted from a change schedule of the explanatory variable in the prediction model do not meet the operation criterion.

14. A plant control system, comprising:
the plant operating condition determination device according to claim 1; and
a control device configured to control a final control element of the plant, based on the command value input from the manipulated variable change unit.

15. A non-transitory storage medium storing a program for determining a plant operating condition, configured to cause a computer to execute:
a step of judging whether a first predicted value of an operation index meets an operation criterion of a plant, the first predicted value being obtained by inputting a scheduled change value of one or more manipulation parameters to a prediction model showing a correlation between the operation index of the plant and an explanatory variable including a plurality of manipulation parameters of the plant;
a step of judging whether a second predicted value of the operation index meets the operation criterion of the plant, the second predicted value being obtained by inputting a virtual change value of the one or more manipulation parameters to the prediction model, wherein a change amount of the virtual change value from a current value of the one or more manipulation parameters is greater than that of the scheduled change value; and
a step of outputting the scheduled change value as a command value of the one or more manipulation parameters if the first predicted value and the second predicted value meet the operation criterion.

16. A method for determining a plant operating condition, comprising:
a step of judging whether a first predicted value of an operation index meets an operation criterion of a plant, the first predicted value being obtained by inputting a scheduled change value of one or more manipulation parameters to a prediction model showing a correlation between the operation index of the plant and an explanatory variable including a plurality of manipulation parameters of the plant;
a step of judging whether a second predicted value of the operation index meets the operation criterion of the plant, the second predicted value being obtained by inputting a virtual change value of the one or more manipulation parameters to the prediction model, wherein a change amount of the virtual change value from a current value of the one or more manipulation parameters is greater than that of the scheduled change value; and
a step of outputting the scheduled change value as a command value of the one or more manipulation parameters if the first predicted value and the second predicted value meet the operation criterion.
